(19) United States
(12) Patent Application Publication
(10) Pub. No.: US 2008/0270480 A1
(43) Pub. Date: Oct. 30, 2008

(54) METHOD AND SYSTEM OF DELETING FILES FROM A REMOTE SERVER

(76) Inventor: David H. HANES, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/740,462

(22) Filed: Apr. 26, 2007

(51) Int. Cl. G06F 12/00

(52) U.S. Cl. 707/200

(57) ABSTRACT

A method and system of deleting files from a remote server. At least some of the illustrative embodiments are home network system comprising a computer system comprising a keyboard and a display device, and a server coupled to the computer system (the server configured to execute an operating system program). When the operating system is commanded to delete a file from a first location (the command in response to a request from the computer system to delete a file on the server), the operating system is configured to move the file from the first location on the server to a recycle location.

### BACKGROUND

Computer networks enable various independent computer systems to communicate with each other. In some cases, the computer systems share files, and with proper initialization and setup the files physically stored on a distant computer system appear as files stored locally. However, while locally stored files and files stored at distant locations may appear the same from the perspective of the user, those files are treated differently for some operations. For example, when a user commands the deletion of a locally stored file, most operating systems do not permanently delete the file; but rather, the operating systems move the “deleted” local file to a recycle location. In this way, if the deletion was inadvertent, the file may be recovered from the recycle bin.

By contrast, when a user commands deletion of a non-locally stored file (e.g., a file on a server accessible over a network), the command to delete is sent to the distant computer system using network protocols. When the command to delete is received at the distant computer system, the operating system of the distant computer system permanently deletes the file (even if the operating system performs the recycle operation for locally generated delete commands). Thus, though local and non-local files may appear indistinguishable from the perspective of a user, inadvertent deletion of one file is recoverable, while inadvertent deletion of another file is unrecoverable.

### BRIEF DESCRIPTION OF THE DRAWINGS

For a detailed description of exemplary embodiments, reference will now be made to the accompanying drawings in which:

FIG. 1 shows a system in accordance with various embodiments;

FIG. 2 shows in greater detail a home network server in accordance with various embodiments; and

FIG. 3 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

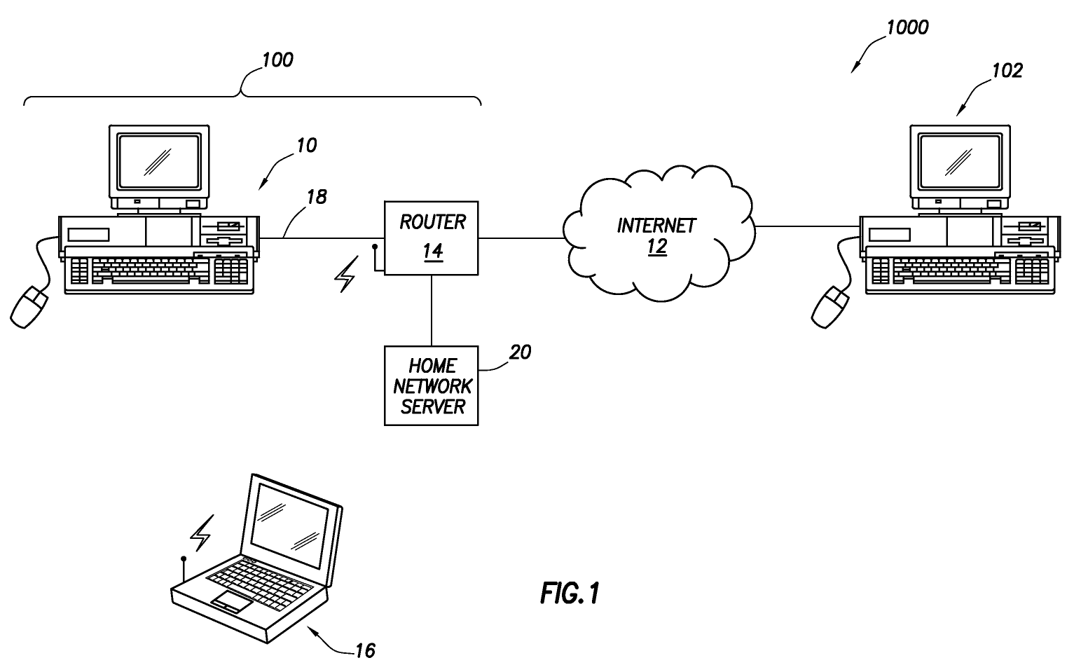

FIG. 1 illustrates a system 1000 in accordance with at least some embodiments. In particular, the system 1000 comprises a home network system 100 and a remote computer system 102. The home network system 100 comprises an illustrative desktop computer system 10 coupled to the Internet 12 by way of a router 14. The home network system 100 also comprises a second computer system, in this case a portable computer system 16, coupled to the Internet 12 by way of the router 14. Each of the computer systems 10, 16 and 102 are configured to execute user programs, accept input data and display output data. In the embodiments illustrated in FIG. 1, desktop computer system 10 couples to the router by way of a hardwired connection 18 (e.g., an Ethernet connection) and illustrative portable computer system 16 couples to the router 14 wirelessly (e.g., IEEE 802.11, Bluetooth). However, computer systems may couple to the router in a hardwired fashion and/or wirelessly without regard to their portability. Further, while the home network system 100 of FIG. 1 shows only one desktop computer system 10 and one portable computer system 16, any number of computer systems may be coupled to the router using any networking functionality.

The home network system 100 of FIG. 1 also comprises a home network server 20 coupled to the router 14. The home network server 20 is a storage device and/or server available to any computer system of the home network system 100 (e.g., desktop computer system 10 or portable notebook computer system 16), and in some cases the home network server 20 is also available to the remote computer system 102. The home network server 20 may be, for example, the central repository for data generated by computer systems of the home network system 100. In the embodiments illustrated in FIG. 1, the storage implemented by home network server 20 is accessible to other computer systems by way of any suitable currently available networking technology or networking communication protocol (e.g., Internet Protocol (IP), Transmission Control Protocol/Internet Protocol (TCP/IP), server message block (SMB)/common internet file system (CIFS)), or any after-developed networking protocol. Thus, the home network server 20 operates, at least in part, as a network attached storage (NAS) device.

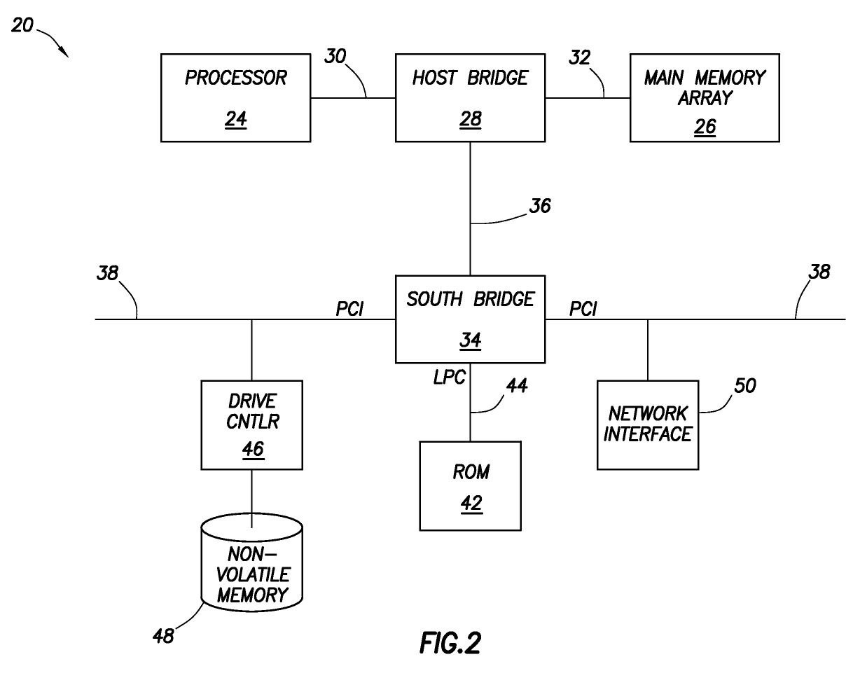

FIG. 2 illustrates in greater detail an embodiment of the home network server 20. In particular, home network sever 20 comprises a processor 24 coupled to a main memory array 26 and various other components through host bridge 28. The processor 24 couples to the host bridge 28 (sometimes referred to as a “north bridge” because of its location in computer system drawings) by way of a host bus 30, or the host bridge 28 may be integrated into the processor 24. The processor 24 may be one of many available processors, and thus the home network server 20 may implement other bus configurations or bus-bridges in addition to, or in place of, those shown in FIG. 2.

Main memory array 26 couples to the host bridge 28 through a memory bus 32. The host bridge 28 comprises a memory control unit that controls transactions to the main memory 26 by asserting control signals for memory accesses. The main memory array 26 functions as the working memory for the processor 24 and comprises a memory device or array of memory devices in which programs, instructions and data are stored. The main memory array 26 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM).

Still referring to FIG. 2, the home network server 20 also comprises a second bridge 34 that bridges the primary expansion bus 36 to various secondary expansion buses, such as the peripheral component interconnect (PCI) bus 38 and the low pin count (LPC) bus 44. The second bridge 34 may be referred to as the “south bridge” because of its location in computer system drawings. Read only memory (ROM) 42 couples to the south bridge 34, such as by the LPC bus 44. The ROM 42 contains software programs executable by the processor 24 to enable the computer system components to perform tasks such as acting as a network attached storage device.

Also coupled to the illustrative PCI bus 38 is a network interface 50. In alternative embodiments, the functionality of the network interface 50 is integrated onto the motherboard along with the bridges 28 and 34. Regardless of the precise location where the network interface is implemented, the network interface 50, and particularly the communication port the network interface provides, enables the home network storage 20 to communicate with other computer systems on the home networking system 100 (through the router 14 of FIG. 1).

Because the home network server 20 is designed to act as a server for the home network system 100, and possibly to reduce cost, in accordance with at least some embodiments the home network server 20 does not support direct coupling of a display device and/or keyboard. Thus, in some embodiments a home network sever 20 does not comprise a graphics controller that couples to a display, and also does not comprise an input/output (I/O) controller that couples to I/O devices such as a keyboard and mouse. To the extent administration is performed on the home network server 20, the administration may be accomplished remotely using other computer systems (e.g., desktop computer system 10 or portable computer system 16) in the home network system 100.

The home network server 20 further comprises a drive controller 46 coupled to the south bridge 34 by way of the illustrative PCI bus 38. In alternative embodiments, the drive controller may couple to the primary expansion bus 36, or any other currently available or after-developed expansion bus. The drive controller 46 controls the non-volatile memory 48, such as a hard drive or optical drive. In some embodiments, the home network server 20 implements a single hard drive where computer systems of the home network can store and retrieve data and programs. In alternative embodiments, the home network server 20 implements a redundant array of independent (or inexpensive) devices (RAID) system where the data and instructions written to the home network server are duplicated across multiple hard drives to implement fault tolerance.

The non-volatile memory stores an operating system, which operating system is executed by the processor 24 during operation of the home network server 20. Operating systems are sets of programs that control the hardware and applications of a computer system (such as home network server 20), e.g., operating system control process task scheduling (that is, controlling which process is executed on the processor during each time slice), transport layer network connections, and file-level control of files stored on the non-volatile memory 48 (e.g., directory control and file deletion). It is noted that the operating system of the home network server 20 may be different from the operating systems implemented on the computer systems 10, 16 and 102.

In accordance with the various embodiments, in response to remotely-sourced file deletion commands, the operating system moves the file to which the deletion command is directed to a recycle location, such that the file appears deleted, but is recoverable. In particular, the home network server 20 communicatively couples to the desktop computer system 10, portable computer system 16, and possibly the remote computer system 102 by way of a networking protocol (e.g., SMB, CIFS). Using the networking protocol, any of the computer systems 10, 16 and 102 may request deletion of a particular file on the home network server 20. In some embodiments, the request to delete the file is received by a “server application” running on home network server 20, and the request passed to the operating system. In other embodiments, the operating system itself implements the “server application,” and thus the operating system may receive the request directly. In response to the command to delete the particular file, a portion of the operating system responsible for file deletion (hereinafter just operating system) is called or instantiated, and passed an indication of the identity and/or location of the particular file.

In accordance with various embodiments, the operating system, when requested to delete a file, analyzes the location of the file. If the file is in a location in the file system other than the recycle location, the operating system moves the file to a recycle location, and indicates deletion of the file. In some embodiments, the particular file is compressed in the recycle location, such that upon the “deletion” the available space on the non-volatile memory device is increased. If, upon analysis, the operating system determines that the particular file resides in a recycle location, the operation system actually removes the file from the non-volatile memory device. In some embodiments, files in the recycle location may be viewed by way of a interface (e.g., a web-based HTTP interface), and selected files restored from the recycle location to their original or previous locations.

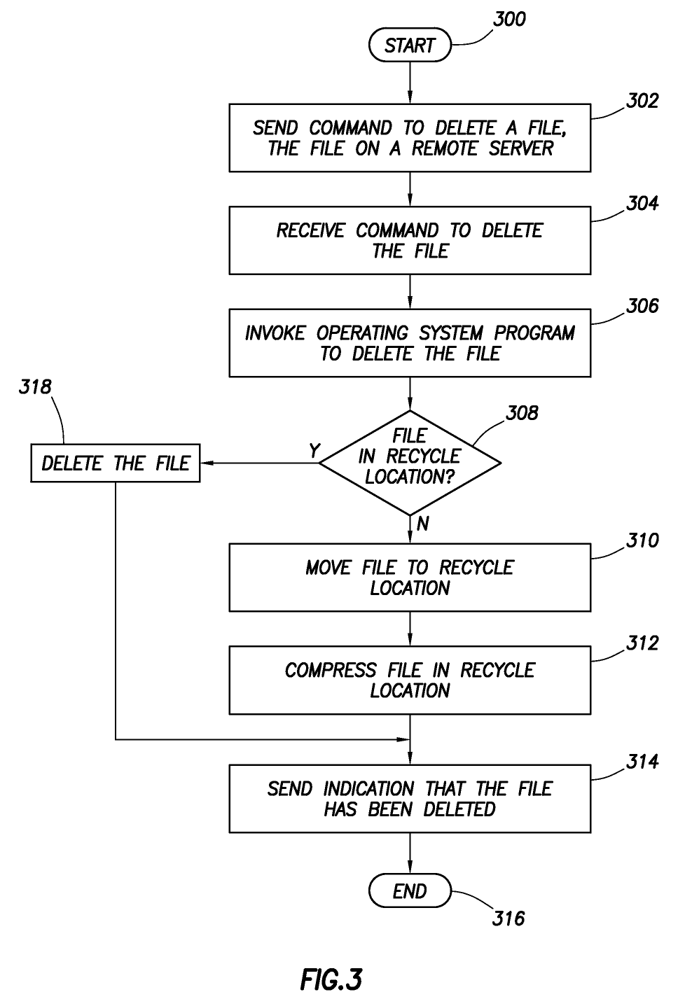

FIG. 3 shows a method (software) in accordance with various embodiments. In particular the method starts (block 300), and sends a command to delete a file, the file on a remote server (block 302). For example, a computer system 10, 16, 102 coupled to a home network server 20 may send a delete command by way of a network communication protocol (e.g., SMB, CIFS). Thereafter, the command is received (block 304), and based on the received delete command a portion of the operating system of home network server 20 is invoked (block 306).

Still referring to FIG. 3, the portion of the operating system invoked in response to the command to delete makes a determination as to the location of the file (block 308). If the location of the file to be deleted is in other than a recycle location, the file is moved to a recycle location (block 310). Optionally, the file may be compressed in the recycle location (block 312) such that the “deletion” of the file results in additional storage space on the non-volatile memory. An indication is sent to the requesting computer system that the file has been deleted (block 314), and the illustrative process ends (block 316).

Returning to the determination of the location of the file to be deleted (block 308), if the file to be deleted already resides in a recycle location (indicating that the file had previously “deleted”), then the file is deleted from the non-volatile memory of the remote server (block 318). After deletion of the file, the operating system sends an indication to the requesting computer system that the file has been deleted (block 314), and the illustrative process ends (block 316). Thus, as discussed above, in the event that a file was inadvertently deleted, the first “deletion” moves the file to a recycle location, giving the user of the remote computer an opportunity to retrieve the “deleted” file. In the event the user requests deletion of the file from the recycle location, the file is deleted (e.g., name removed from the directory tree and/or overwritten) from non-volatile memory of the server.

From the description provided herein, those skilled in the art are readily able to combine software created as described with appropriate general purpose or special purpose computer software to create a computer system and/or computer subcomponents in accordance with the various embodiments, to create a computer system and/or computer subcomponents for carrying out the methods of the various embodiments and/or to create a computer-readable media for storing a software program (e.g., an operating system), to implement the method aspects of the various embodiments.

The above discussion is meant to be illustrative of the principles and various embodiments of the present invention. Numerous variations and modifications will become apparent to those skilled in the art once the above disclosure is fully appreciated. For example, when a file on a non-volatile storage devices is moved, the physical location of the file on the non-volatile memory device may not change, and instead an entry in a directory tree may indicate a new location; nevertheless, the file is considered moved for purposes of this disclosure and claims. Moreover, the recycle location need not be on the same network server, and thus the recycle may reside at a remote location. It is intended that the following claims be interpreted to embrace all such variations and modifications.

What is claimed is:

1. A home network system comprising:
a computer system comprising a keyboard and a display device;
a server coupled to the computer system, the server configured to execute an operating system program;
wherein when the operating system is commanded to delete a file from a first location, the command in response to a request from the computer system to delete a file on the server, the operating system is configured to move the file from the first location on the server to a recycle location.

2. The home network system according to claim 1 wherein when the operating system is commanded to delete a file from the recycle location, the operating system is configured to delete the file from the recycle location.

3. The home network system according to claim 1 wherein when the operating system moves the file to the recycle location, the operating system is configured to compress the file.

4. The home network system according to claim 1 further comprising wherein the computer system utilizes an operating system different than the operating system of the server.

5. The home network system according to claim 1 wherein the recycle location resides on the server.

6. The home network system according to claim 1 wherein the server does not comprise hardware to communicate with a directly coupled keyboard.

7. The home network system according to claim 1 wherein the server does not comprise hardware to communicate with a directly coupled display device.

8. The home network system according to claim 1 wherein the server couples to the computer system by way of a networking technology.

9. A home network server comprising:
a processor;
an operating system stored on a non-volatile memory device coupled to the processor, the operating system executed by the processor;
wherein the home network server is configured to accept a command from a remote computer system, the command to delete a particular file stored on a memory device of the network server; and
wherein when the operating system is commanded to delete the particular file from a first location, the operating system is configured to move the particular file from the first location a recycle location on the memory device.

10. The home network server according to claim 9 further comprising wherein when the operating system moves the file, the operating system is further configured to compress the particular file.

11. The home network server according to claim 9 further comprising wherein when the operating system is commanded to delete the file from the recycle location, the operating system deletes the particular file.

12. The home network server according to claim 9 wherein the operating system is different than an operating system executed on the remote computer system.

13. The home network server according to claim 9 further comprising a network communication port coupled to the processor, and wherein the home network server is configured to accept the command over the network communication port.

14. A computer-readable medium storing an operating system program that, when executed by a processor, causes the processor to:
operate as an operating system for a computer system;
make a file on the computer system available to a remote computer system;
receive a request to delete the file, the request based on a command to delete the file from the remote computer system; and
move the file from a first location to a second location in response to the request to delete.

15. The computer-readable medium according to claim 14 wherein when the processor moves the file, the operating system program causes the processor to compress the file in the second location.

16. The computer-readable medium according to claim 14 wherein the operating system program further causes the processor to delete the file from the second location in response to receipt of a request to delete the file from the second location.

17. A method comprising:
receiving, by a first computer system, a request to delete a file stored by the first computer system, the request from a remotely coupled computer system;
invoking an operating system program to delete the file; and
moving, by the operating system program, the file from a first location to a second location, and indicating successful deletion of the file.

18. A home network system comprising:
a means for executing user programs, accepting input data, and displaying output data;
a means for remote storage of a file, the means for remote storage coupled to the means for executing by way of a means for remote computer communication; and
a means for providing operating system services executing on the means for remote storage;
wherein when the means for providing operating system services is commanded to delete a file from a first location, the command in response to a request from the means for executing, the means for operating system services is configured to move the file from the first location on the mans for remote storage to a recycle location.

19. The home network system according to claim 18 wherein when the means for providing operating system services is commanded to delete a file from the recycle location, the means for providing operating system services is configured to delete the file from the recycle location.

20. The home network system according to claim 18 wherein the means for providing operating system services moves the file to the recycle location, the means for providing operating system services is configured to compress the file.
